(19) United States
(12) Patent Application Publication
(10) Pub. No.: US 2017/0008004 A1
(43) Pub. Date: Jan. 12, 2017

(54) GRINDING MEDIA FABRICATION

(71) Applicant: DONHAD PTY LTD, Bassendean (AU)

(72) Inventors: Paul William Shelley, Kalamunda (AU); Amir Hossein Bahri, Booragoon (AU); Michael Laurence Bovell, Highgate (AU)

(21) Appl. No.: 15/163,746

(22) Filed: May 25, 2016

(30) Foreign Application Priority Data
Jul. 6, 2015 (AU) 2015902663

(51) Int. Cl. B02C 17/20; C21D 6/00; C21D 1/22; C22C 38/50; C22C 38/48; C22C 38/02; C22C 38/44; C22C 38/42; C22C 38/06; C22C 38/00; C22C 38/04; C21D 9/36; C22C 38/46

(52) U.S. Cl. CPC B02C 17/20; C21D 9/36; C21D 6/002; C21D 6/005; C21D 6/008; C21D 1/22; C22C 38/50; C22C 38/48; C22C 38/46; C22C 38/44; C22C 38/42; C22C 38/06; C22C 38/008; C22C 38/04; C22C 38/002; C22C 38/02; C21D 2211/008

(57) ABSTRACT

A steel ball for use as grinding media in a mill, and a method of fabricating such ball are disclosed. The steel ball has the following composition, by weight

| | |
|---|---|
| Carbon | 1.05% ± 0.05 |
| Silicon | 0.55% ± 0.45 |
| Manganese | 0.75% ± 0.60 |
| Chromium | 0.90% ± 0.60 |
| Molybdenum | 0.20% ± 0.20 |
| Phosphorous | 0.15% ± 0.15 |
| Sulphur | 0.015% ± 0.015 |
| Nickel | 0.225% ± 0.225 |
| Copper | 0.225% ± 0.225 |
| Vanadium | 0.05% ± 0.05 |
| Aluminium | 0.05% ± 0.05 |

with the balance being iron. The ball has an average surface hardness of 60-65 HRC and an average volumetric hardness of 59-65 HRC. The ball has a tempered martensitic microstructure and is formed by heating a billet, forging the billet to form a substantially spherical ball, quenching and then tempering the ball.

### FIELD OF THE INVENTION

The present invention relates to forged grinding media which are used in grinding mills of mineral processing plants to reduce the particle size of mineral ore.

### BACKGROUND ART

During the ore processing, the steel balls are progressively reduced in size and thus have a limited operational life. The length of the operational life is an important economic criterion upon which purchase of the balls by the mill operator is based.

There are basically two types of mills (SAG mill and ball mill), in which grinding balls are used. There are also two types of balls used in grinding mills, namely cast steel grinding balls and forged steel grinding balls. The present invention relates to forged grinding balls used in ball mills (ball size 27 mm-80 mm), for which wear resistance is the primary performance characteristics followed by impact toughness as the secondary characteristic. The wear resistance of forged grinding balls can be improved by three actions, namely:
(i) increasing the average volumetric hardness of the ball,
(ii) increasing the Carbon content, and
(iii) improving the microstructure of the ball to have the least amount of retained austenite while maintaining a tempered martensitic microstructure.

The grades of steel being used by different forged grinding ball manufacturers around the world are mainly the AISI 51xx (Chromium steel) series with a maximum Carbon content of 0.95%±0.05 by weight. This grade (known as 0.95% Carbon) is supplied by a few suppliers including the present applicant (Donhad). Other alloying elements of the standard AISI 51xx series could be altered to achieve the desired properties. However some manufacturers are using the AISI 52100 bearing steel grade with 1.00%±0.05 Carbon content for small ball sizes up to 40 mm.

A generic prior art process of making forged grinding balls is shown in FIG. 1. The process starts with heating the steel bar to its forging temperature. This is done either by using an induction heating process or a gas furnace. Once the bar is at the desired forging temperature, it will be either rolled or pressed to form the balls. The third step is equalising the ball temperature to a desired temperature for a set period. Then the balls are quenched to a desired temperature. Finally the balls are tempered to achieve the desired hardness and microstructure.

U.S. Pat. Nos. 6,632,303 and 6,802,914 (Jager) disclose prior art forged balls in which the hardness of the core of the ball is different from the hardness of the outer shell of the ball. Such a variation in properties between the core and the outer shell is liable to lead to residual stresses giving rise to spalling or other fracture of the bail.

### GENESIS OF THE INVENTION

The Genesis of the present invention is a desire to increase the operational life of forged ball mill grinding balls by developing a new grade of steel that contains 1.05%±0.05 of Carbon and other alloying elements to deliver the desired surface and volumetric hardness. In particular, in the preferred embodiment of the present invention the surface hardness and the interior hardness are substantially the same.

The effectiveness of any change in the performance of the ball can be verified by either or both of a field test widely known as Marked Ball Wear Test (MBWT) and a test utilising a Pin on Disk wear test apparatus.

### SUMMARY OF THE INVENTION

In accordance with a first aspect of the present invention there is disclosed a steel for use in fabricating steel balls for use as grinding media in a mill, said steel comprising:

a Carbon content of approximately 1.05% by weight,

a Silicon content of approximately 0.55% by weight,

a Manganese content of approximately 0.75% by weight,

a Chromium content of approximately 0.90% by weight,

a Molybdenum content of approximately 0.20% by weight,

and all other elements other than iron are present at a concentration of less than 0.5% by weight, and

the balance being iron.

In accordance with a second aspect of the present invention there is disclosed a method of fabricating steel balls for use as grinding media in a mill, said method comprising the steps of:

heating an elongate steel billet,

forging said billet to form a substantially spherical ball, and

quenching said ball,

wherein said steel comprises

a Carbon content of approximately 1.05% by weight,

a Silicon content of approximately 0.55% by weight,

a Manganese content of approximately 0,75% by weight,

a Chromium content of approximately 0.90% by weight,

a Molybdenum content of approximately 0.20% by weight,

and all other elements other than iron are present at a concentration of less than 0.5% by weight,

the balance being iron,

and wherein the hardness of the exterior and interior of said ball is substantially the same.

A ball fabricated by the method is also disclosed.

Preferably the quenching comprises said ball having an initial temperature in the range of from 760-950° C., the temperature of the quenching water is from 20° C. to 50° C. and the effective tempering temperature is in the range of 110° C. to 170° C.

Preferably,

the Carbon content is 1.05%±0.05 by weight,

the Silicon content is 0.55%±0.45 by weight,

the Manganese content is 0.75%±0.60 by weight,

the Chromium content is 0.90%±0.60 by weight, and

the Molybdenum content is 0.20%±0.20 by weight,

More preferably,

the Phosphorus content is 0.015%±0.015 by weight,

the Sulphur content is 0.015%±0.015 by weight,

the Nickel content is 0.225%±0.225 by weight,

the Copper content is 0.225%±0.225 by weight,

the Vanadium content of approximately 0.05%±0.05 by weight, and

the Aluminium content is approximately 0.05%±0.05 by weight

### BRIEF DESCRIPTION OF THE DRAWINGS

A preferred embodiment of the present invention will now be described, by way of example only, with reference to the accompanying drawings in which:

FIG. 1 is a flowchart depicting the steps of the prior art process for making forged balls,

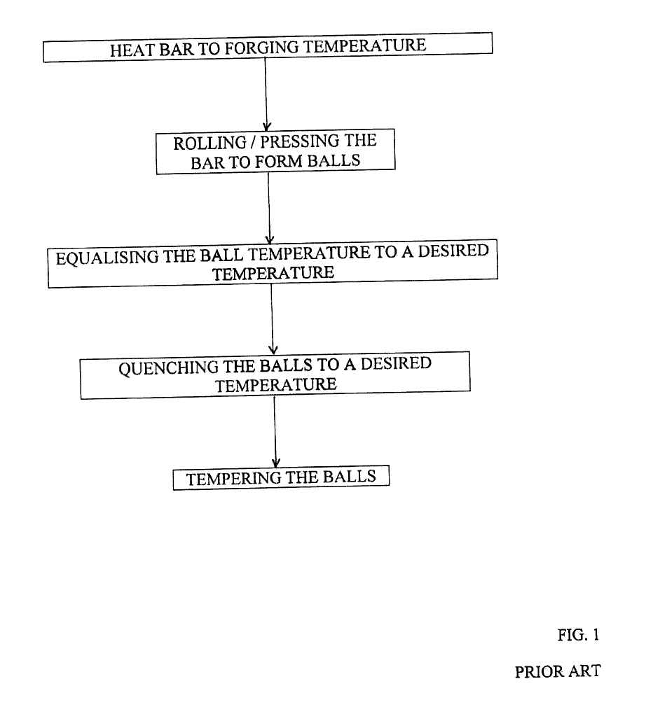

FIG. 2 is a graph of a pin on disk abrasion test showing the frictional force difference between a prior art 0.95% Carbon grade and a 1.05% Carbon grade ball of the preferred embodiment, and

FIG. 3 is a photograph of the microstructure of a representative ball.

### DETAILED DESCRIPTION

In accordance with the preferred embodiment of the present invention the operating life of steel balls can be increased by increasing the surface hardness and volumetric hardness of the ball, and/or reducing the frictional force between the balls in contact as a result of increased Carbon content. This is achieved by varying the chemical composition of the raw steel of the ball.

In the preferred embodiment, the chemical composition of the steel is selected to be within the following ranges. The present invention includes within its scope this grade or composition of steel made by either the Electric Arc Furnace (EAF) steel making process or the Basic Oxygen Furnace (BOF) steel making process.

TABLE I

| Main Elements in | Maximum concentration | Minimum concentration |
|---|---|---|
| addition to iron | % by weight | % by weight |
| Carbon | 1.10 | 1.00 |
| Silicon | 1.00 | 0.10 |
| Manganese | 1.35 | 0.15 |
| Chromium | 1.50 | 0.30 |
| Molybdenum | 0.40 | 0.00 |

TABLE II

| Minor Elements in | Maximum concentration | Minimum concentration |
|---|---|---|
| addition to iron | % by weight | % by weight |
| Phosphorus | 0.03 | 0.00 |
| Sulphur | 0.03 | 0.00 |
| Nickel | 0.45 | 0.00 |
| Copper | 0.1 | 0.00 |
| Vanadium | 0.1 | 0.00 |
| Aluminium | 0.1 | 0.00 |

The initial bar was induction heated to 920-1050° C. and then roll formed or forged at temperatures within the range of 900-1030° C. to form a ball. The balls had an intended final diameter of the finished ball in the range of 27 mm-80 mm. The ball temperature was then equalised for between 60 to 240 seconds.

The balls were then water quenched with the initial ball temperature being in the range of 760-950 ° C. and the temperature of the quenching water being in the range of 20-50 ° C. The balls were retained in the quenching water for a period of typically X-Y seconds to achieve an equalised ball temperature of 110-170° C. Thereafter the balls were tempered at a tempering temperature in the range of from 110-170° C. for a time of typically A-B seconds/minutes,

The result is a steel ball having a microstructure which is tempered martensitic with secondary phases towards the centre of the ball, and an average surface hardness of from 60-65 HRC and an average volumetric hardness of 59-65 HRC. Representative samples of the balls were cut through the centre and the interior surface polished and etched to permit micro-analysis. In this way the Rockwell hardness of both the exterior and the interior of the forged ball can be determined.

Two MBWTs were carried out on the resulting steel ball having the 1.05%±0.05 of Carbon, and a prior art ball having 0.95%±0.05 of Carbon. These tests showed a minimum 5% improvement in wear rate against 0.95% Carbon grade.

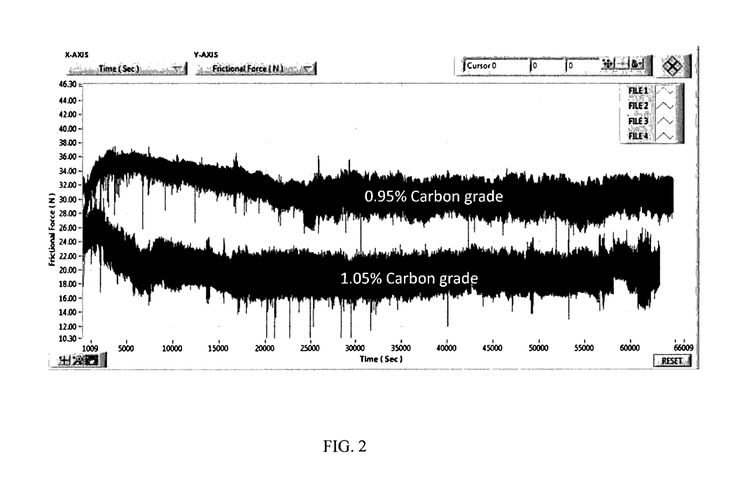

The ball produced with this grade of steel also exhibited less frictional force during a pin on disk apparatus test. FIG. 2 shows the reduction in frictional force of the 1.05% Carbon grade ball during a pin on disk wear test as against the 0.95% C grade ball.

After the priority date, tests were conducted at the No. 1 ball mill at Mount Isa Mines in Queensland Australia where the mill is grinding lead-zinc concentrate. From a specific date, all new grinding media introduced into the mill were steel balls as described above. The consumption rate for the mill over time was compared with the historical consumption rates. The historical consumption rate was 0.38 kg per dry metric ton and the consumption rate of the new balls was 0.34 kg per dry metric ton. This is an apparent saving of 10.5%. However, the actual saving may be greater than this since the length of time during which the new balls were supplied to the mill did not exceed the anticipated life of all of the old balls.

Furthermore, the applicant supplied a third party testing laboratory with three 2.5″ (63.5 mm) diameter grinding balls as above for metallurgical examination. All samples had been roll formed to the final size and shape. The results were as follows:
The surface quality was good.
There were no potentially detrimental surface defects.
On a weight basis, the balls were an average of 3.4% undersize relative to a 2.5″(63.5 mm) nominal ball.
With an average surface hardness of Rockwell 62 HRC the balls did meet the recommended minimum 60 HRC surface hardness.
Interior hardness readings were appropriate for a through hardened low residual stress ball design.
With an average alloy calculated Ms(N) value of 276° F. (135.5° C.) potential wear resistance of the alloy was near optimal. Marked ball wear testing provided data that lower Ms(N) alloys, when optimally heat treated, can produce lower wear rates.
The three samples had an average calculated hardenability Grossman Di of 4.2″ (106.7 mm), which was appropriate for the ball diameter.
Phosphorous and sulfur were at acceptable levels in the material.
The average grain size at the surface (ASTM #6) and at the center (ASTM #6) is very good.

Based on the metallurgical properties obtained from the 2.5″ (63.5 mm) balls, the balls would be expected to provide a near optimal wear rate in normal impact secondary mill applications. All metallurgical properties of these balls met or exceeded the recommended minimums. Toughness should be adequate for the application, but only either controlled drop ball testing or charge observations can determine ball toughness requirements for a specific application.

Sample Preparation

Upon arrival, the test 2.5″ (63.5 mm) ball samples were marked for identification, thoroughly examined, weighed and metallurgically sectioned for subsequent hardness and chemistry evaluations. Due to the sensitivity of heat treated high carbon steels to sample preparation, the metallurgical cutting practices utilized in the sample sectioning were designed to eliminate microstructural alteration through a low rate of metal removal and high coolant flow. The plane of the wafer extracted from the balls was random relative to the original bar rolling and ball forging axis. Hardness testing was performed on a Wilson Model 3JR Rockwell Hardness Tester using a “C” Brale penetrator with a 150-kg load. For testing control, 65.6±0.5 HRC and 56.2±1.0 HRC calibration blocks were utilized to assure accuracy of the readings. Chemistry data was obtained through optical emission spectrographic (OES) and combustion analysis (LECO) methods.

Physical Properties

TABLE III
BALL SAMPLE - SIZE and DESCRIPTION

| Sample | Nominal | Sample | Sample | Weight | Percent | Calculated | Diameter |
|---|---|---|---|---|---|---|---|
| No. | Size (in) | Description | (g) | (lbs) | Oversize | (in.) | (mm) |
| 1 | 2.5 | New Whole Ball | 1,021 | 2.25 | −3.0 | 2.47 | 62.9 |
| 2 | 2.5 | New Whole Ball | 1,016 | 2.24 | −3.4 | 2.47 | 62.8 |
| 3 | 2.5 | New Whole Ball | 1,012 | 2.23 | −3.9 | 2.47 | 62.7 |

TABLE IV
CHEMICAL COMPOSITION (WEIGHT PERCENT)

| Sample | | | | | | | | | | | | | | |
|---|---|---|---|---|---|---|---|---|---|---|---|---|---|---|
| No. | C | Mn | P | S | Si | Ni | Cr | Mo | Cu | Ti | V | Nb | Sn | AI |
| 1 | 1.08 | 0.49 | 0.019 | 0.002 | 0.59 | <0.001 | 0.92 | 0.005 | 0.02 | 0.008 | 0.006 | <0.001 | <0.001 | 0.034 |
| 2 | 1.06 | 0.48 | 0.019 | 0.002 | 0.57 | <0.001 | 0.92 | 0.005 | 0.01 | 0.008 | 0.005 | <0.001 | <0.001 | 0.033 |
| 3 | 1.06 | 0.48 | 0.022 | 0.002 | 0.59 | <0.001 | 0.92 | 0.005 | 0.01 | 0.008 | 0.005 | <0.001 | <0.001 | 0.033 |

TABLE V
ROCKWELL HARDNESS (HRC) AT DEPTH BELOW SURFACE (IN.)

| SAMPLE | | | | | | | | | | | | |
|---|---|---|---|---|---|---|---|---|---|---|---|---|
| NO. | 0.01 | 0.02 | 0.03 | 0.04 | 0.05 | 0.06 | 0.07 | 0.08 | 0.09 | 1.0 | 1.1 | 1.2 |
| 1 | 62 | 63 | 62 | 62 | 61 | 60 | 60 | 60 | 60 | 59 | 59 | 59 |
| 2 | 62 | 62 | 62 | 61 | 61 | 61 | 60 | 62 | 61 | 60 | 63 | 62 |
| 3 | 63 | 63 | 62 | 61 | 61 | 61 | 60 | 61 | 62 | 63 | 63 | 61 |

TABLE VI
Prior Austenitic Grain Size - Shepherd Method

| Sample No. | Ball Surface | Ball Center |
|---|---|---|
| 1 | ASTM #7 | ASTM #7 |
| 2 | ASTM #6 | ASTM #6 |
| 3 | ASTM #6 | ASTM #6 |

The criteria for grain size in grinding media steels are as follows:

TABLE VII

| | |
|---|---|
| Fine Grain | ASTM #7 through #9 |
| Intermediate Grain | ASTM #4 through #6 |
| Coarse Grain | ASTM #1 through #3 |

Observations by the Testing Laboratory

The three samples of 2.5″ diameter grinding balls provided for metallurgical characterization each had good surface quality. There were no potentially harmful cracks, surface seams or laps. Relative to the weight of a nominal 2.5″ diameter ball, the samples were 1.7% undersize. The balls had been roll formed, heat treated, quenched and tempered.

For optimal wear resistance in normal impact secondary mill applications, a minimum surface hardness of Rockwell 60 HRC is recommended. If ball breakage or spalling is noted in the ball charge, surface hardness levels below Rockwell 60 HRC may be required. The balls tested did meet the recommended minimum surface hardness with its average 62 HRC. The hardness profile from the surface to the center indicates the balls were correctly through hardened and would be expected to have low residual internal stresses. Low residual stress is advantageous as it minimizes the cumulative effect of normal application induced stress.

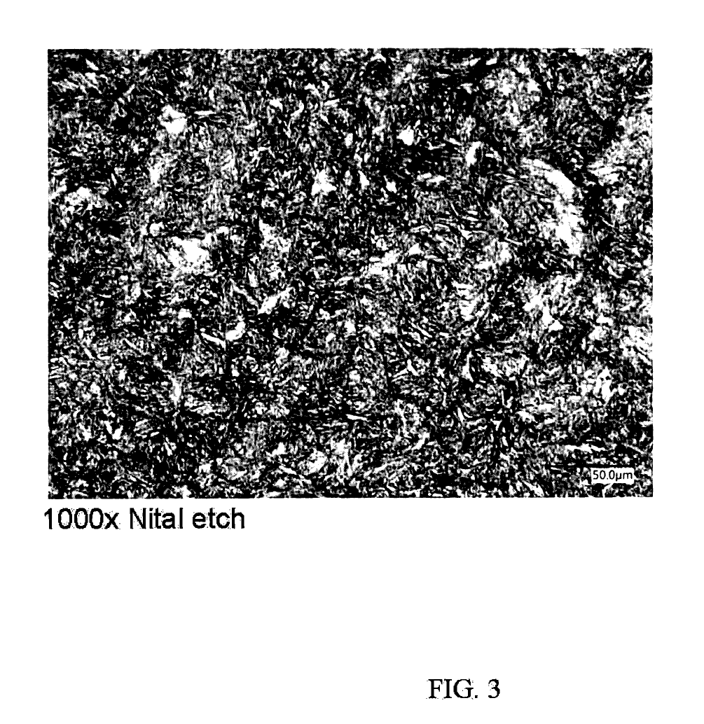

The microstructure shown in FIG. 3 shows the expected tempered martensite with retained austenite. Conventional alloy design experience relies on a high volume fraction of retained austenite to provide bulk fracture toughness. Lower martensite start temperatures lead to higher percentages of metastable retained austenite in the microstructure. Retained austenite, when in service, can transform to martensite in a thin layer at the ball surface from impact stresses. This martensite is of very high hardness and excellent wear resistance.

With an average alloy calculated Ms(N) value of 276° F. (106.7° C.), the 2.5″ test balls would be anticipated to develop a near optimal wear rate in normal impact secondary mill grinding applications Alloy hardenability was acceptable for the ball size with a calculated Grossman Di of 4.2″ (106.7 mm). Hardenability elements utilized were manganese and chromium. Phosphorus and sulfur, at elevated levels, can develop grain boundary films or non-metallic inclusions, respectively, which can reduce impact toughness. These potentially harmful elements, however, were at acceptable levels in the material.

The average estimated grain size of ASTM #6 at the surface and ASTM #6 at the center in the extracted wafers was intermediate. The grain sizes were very good. Intermediate grain microstructures have greater fracture toughness than coarse grain microstructures. Aluminium was used as the grain refining element.

No defects were noted in the centerline portion of the samples and there were no indications of detrimental hydrogen. Hydrogen-assisted cracking can result in ball breakage and increased wear rate.

Laboratory tests are available for measuring grinding media material toughness, but these tests only measure a small material segment and cannot be scaled to the impact conditions that occur in application. Structural integrity and spalling resistance of a grinding ball are more appropriate characteristics for evaluating toughness. Only controlled drop ball tests or conducting tests in the actual application can be considered viable techniques.

Set out below in Table VIII is a tabular summary of the metallurgical characteristics of the nominal 2.5″ (63.5 mm) ball samples. Included are calculated values of Ms(N) (Martensite start temperature), Di (Grossman hardenability of composition) and the weighted volumetric hardness. The calculated Ms(N) value can be used to estimate heat treatment quenching characteristics as well as the relative wear rates for optimally heat treated materials in a specific application. An alloy with a lower Ms(N) will develop lower wear rates. The Di calculated value can be used to determine the adequacy of the total alloy content for the specific ball size. Prior austenitic grain size is an indication of the compatibility of the heat treatment cycle with the alloy composition and an important characteristic of material toughness.

TABLE VIII
Calculated Metallurgical Data

| | | | | | | | Optimal | |
|---|---|---|---|---|---|---|---|---|
| | | | Weighted | | | | Prior | |
| | | Ideal | Volumetric | | Acceptable | Optimal | Austenitic | |
| | Mn(N) | Diameter | Hardness | Acceptable | Heat | Surface | Grain | Hydrogen |
| Sample | Temp | (inches) | (HRC) | Composition | Treatment | Hardness | Size | Indications |
| 1 | 269° F. | 4.3 | 61.6 | Yes | Yes | Yes | Yes | None |
| | | | | | | | | Noted |
| 2 | 279° F. | 4.1 | 61.5 | Yes | Yes | Yes | Yes | None |
| | | | | | | | | Noted |
| 3 | 280° F. | 4.2 | 62.0 | Yes | Yes | Yes | Yes | None |
| | | | | | | | | Noted |

Notes:
Ms(N) is the martensite start temperature (degrees F.) calculated via the Nehrenberg method. Di is the Grossman method ideal critical diameter (in.) calculated from the alloy composition. Weighted volumetric hardness is a measure of the section average Rockwell hardness. Prior austenitic grain sizeestimated by the Shepherd Method.

Based on the metallurgical properties obtained from the test 2.5″ balls investigated for this report, the balls would be expected to provide a near optimal wear rate in normal impact secondary mill applications. All metallurgical properties of these balls met or exceeded the recommended minimums. Toughness should be adequate for the application, but only controlled drop ball testing or charge observations can determine ball toughness requirements for a specific application.

The foregoing describes only one embodiment of the present invention and modifications, obvious to those skilled in the metallurgy arts, can be made thereto without departing from the scope of the present invention.

The term “comprising” (and its grammatical variations) as used herein is used in the inclusive sense of “including” or “having” and not in the exclusive sense of “consisting only of”.

1. A steel for use in fabricating steel balls for use as grinding media in a mill, said steel comprising:
a Carbon content of approximately 1.05% by weight,
a Silicon content of approximately 0.55% by weight,
a Manganese content of approximately 0.75% by weight,
a Chromium content of approximately 0.90% by weight,
a Molybdenum content of approximately 0.20% by weight,
and all other elements other than iron are present at a concentration of less than 0.5% by weight, and
the balance being iron.

2. The steel as claimed in claim 1 wherein:
said Carbon content is 1.05%±0.05 by weight,
said Silicon content is 0.55%±0.45 by weight,
said Manganese content is 0.75%±0.60 by weight,
said Chromium content is 0.90%±0.60 by weight, and
said Molybdenum content is 0.20%±0.20 by weight.

3. The steel as claimed in claim 1 wherein said elements other than iron are selected from the class consisting of Phosphorus, Sulphur, Nickel, Copper, Vanadium and Aluminium.

4. The steel as claimed in claim 4 wherein:
said Phosphorus content is 0.015%±0.015 by weight,
said Sulphur content is 0.015%±0.015 by weight,
said Nickel content is 0.225%±0.225 by weight,
said Copper content is 0.225%±0.225 by weight,
said Vanadium content of approximately 0.05%±0.05 by weight, and
said Aluminium content is approximately 0.05%±0.05 by weight.

5. A method of fabricating steel balls for use as grinding media in a mill, said method comprising the steps of:
heating an elongate steel billet,
forging said billet to form a substantially spherical ball, and
quenching said ball,
wherein said steel comprises
a Carbon content of approximately 1.05% by weight,
a Silicon content of approximately 0.55% by weight,
a Manganese content of approximately 0.75% by weight,
a Chromium content of approximately 0.90% by weight,
a Molybdenum content of approximately 0.20% by weight,
and all other elements other than iron are present at a concentration of less than 0.5% by weight,
the balance being iron,
and wherein the hardness of the exterior and interior of said ball is substantially the same.

6. The method as claimed in claim 5 wherein said quenching comprises said ball having an initial temperature in the range of from 760-950 ° C., the temperature of the quenching water is from 20° C. to 50° C. and the effective tempering temperature is in the range of 110° C. to 170° C.

7. The method as claimed in claim 5 wherein:
said Carbon content is 1.05%±0.05 by weight,
said Silicon content is 0.55%±0.45 by weight,
said Manganese content is 0.75%±0.60 by weight,
said Chromium content is 0.90%±0.60 by weight, and
said Molybdenum content is 0.20%±0.20 by weight.

8. The method as claimed in claim 5 wherein said elements other than iron are selected from the class consisting of Phosphorus, Sulphur, Nickel, Copper, Vanadium and Aluminium.

9. The method as claimed in claim 8 wherein:
said Phosphorus content is 0.015%±0.015 by weight,
said Sulphur content is 0.015%±0.015 by weight,
said Nickel content is 0.225%±0.225 by weight,
said Copper content is 0.225%±0.225 by weight,
said Vanadium content of approximately 0.05%±0.05 by weight, and
said Aluminium content is approximately 0.05%±0.05 by weight.

10. A forged steel ball fabricated by the method as claimed in claim 5.
